(19) United States
(12) Patent Application Publication
(10) Pub. No.: US 2007/0251889 A1
(43) Pub. Date: Nov. 1, 2007

(54) Biocide-enhanced mechanical treatment of water

(76) Inventors: Freddie L. Singleton, Switzerland, FL (US); Michael J. Mayer, Jacksonville, FL (US); Alexander W. Breen, Richmond Hill, GA (US); Robert Kelsey, Fair Oaks Ranch, TX (US)

Correspondence Address: Joanne Mary Fobare Rossi;Hercules Incorporated, Hercules Plaza, 1313 North Market Street, Wilmington, DE, 19894-0001, US

(21) Appl. No.: 11/641,443

(22) Filed: Dec. 19, 2006

Related U.S. Application Data
(60) Provisional application No. 60/752,171, filed on Dec. 19, 2005.

(51) Int. Cl. C02F 1/50; C02F 1/68

(52) U.S. Cl. 210/764

(57) ABSTRACT

The present invention describes a method of treating an aqueous system with a hydrodynamic water treatment device in conjunction with a biocide.

### CROSS REFERENCE TO RELATED APPLICATIONS

This application is related to U.S. patent application Ser. No. 60/752,171, filed Dec. 19, 2005, from which priority is claimed, the foregoing application is hereby incorporated by reference

### TECHNICAL FIELD

The present invention relates to chemically enhancing inhibition of microorganisms by hydromechanical treatment of water and the use of specific biocides and combinations thereof to inhibit or control growth of microorganisms in aqueous systems, more particularly in industrial process waters.

### BACKGROUND OF THE INVENTION

In the absence of extreme environmental conditions, microorganisms are ubiquitous in natural and man-made aquatic systems. The size and complexity of a microbial community in an aquatic system will depend on many factors from the physico-chemical parameters (available nutrients, temperature, pH, etc.) of the water to prevailing environmental parameters of the surrounding ecosystem. Like natural aqueous systems, industrial water systems can provide an environment suitable for growth of bacteria and other types of microorganisms. Uncontrolled growth of microorganisms in process water can result in large numbers of free-floating (planktonic) cells in the water column and sessile cells on submerged surfaces where conditions favor formation of biofilms.

Regardless of the system, whether natural or man-made, growth of microorganisms in aqueous systems can have serious consequences. For example, uncontrolled microbial growth can range from interference of important industrial processes to degradation and/or spoilage of products to contamination of products. Growth of microorganisms on surfaces exposed to water (e.g., recirculation systems, heat exchangers, once-through heating and cooling systems, pulp and paper process systems) can be especially problematic. Microbiologically-influenced problems in industrial process waters include accelerated corrosion of metals, accelerated decomposition of wood and other biodegradable materials, restricted flow through pipes, plugging or fouling of valves and flow-meters, and reduced heat exchange or cooling efficiency on heat exchange surfaces. Biofilms may also be problematic relative to cleanliness and sanitation in medical equipment, breweries, wineries, dairies and other industrial food and beverage process water systems.

In order to control problems caused by microorganisms in industrial process waters, numerous antimicrobial agents (i.e., biocides) have been employed. Biocides are used alone or in combination to prevent or control the problems caused by growth of microorganisms. Biocides are usually added directly to a process water stream or to a material used in the process. The typical method of addition is such that the biocide is distributed throughout the process system to control planktonic microorganisms and those in biofilms on submerged surfaces.

The type of biocide used in a system will depend on many factors including the nature of the water being treated and specific requirements of the industry. There are many substances, organic and inorganic, used as biocides in industrial process systems.

Issues such as worker safety, handling, and regulatory restrictions provide the basis for the water treatment industry to find alternatives to biocides. Many non-chemical water technologies have been developed and the general categories for such technologies include among others, ultraviolet light and ozone (for disinfecting water), ultrasound (or sonication), electric and electromagnetic fields, including pulsed electrical fields, and hydromechanical, among others.

Hydromechanical water treatment is based on the premise that changes in the chemical composition and other physico-chemical parameters of water occur during treatment. One such technology, marketed by VRTX Technologies, (San Antonio, Tex.) is based on inducing chemical changes in water via hydrodynamic cavitation. This technology treats industrial process waters, primarily in cooling towers to prevent corrosion, scale formation, and deposition.

Hydrodynamic cavitation refers to a process wherein cavities and cavitation bubbles filled with a vapor-gas mixture are formed inside the fluid flow. Cavitation bubbles can also be formed at the boundary of a baffle body because of a local decrease in pressure in the fluid. A great number of vapor-filled cavities and bubbles form if the pressure decreases to a level where the fluid boils. As the fluid and cavitation bubbles flow in a system, they encounter a zone with higher pressure at which point, vapor condensation occurs within the bubbles and the bubbles collapse. The collapse of cavitation bubbles can cause very large pressure impulses. For example, the pressure impulses within the collapsing cavities and bubbles can be tens of thousands of pounds per square inch. The result of hydrodynamic cavitation and other forces exerted on the water range from changes in solubility of dissolved gases to pH changes to formation of free radicals to precipitation of some dissolved ions (e.g., calcium, iron, and carbonate).

Systems designed to induce hydrodynamic cavitation in fluids traditionally have been used as homogenization devices or colloidal mills. Examples of homogenization devices have been described by Ashbrook et al. (U.S. Pat. Nos. 4,645,606; 4,764,283; 4,957,626), Ashbrook (U.S. Pat. Nos. 5,318,702; 5,435,913). Kozyuk (U.S. Pat. Nos. 6,802,639 and 6,502,979) discloses a homogenization device that forms emulsion or colloidal suspensions that have long separation half-lives by use of cavitating flow. Thiruvengadam et al. (U.S. Pat. No. 4,127,332) discloses a system for homogenizing a multi-component stream including a liquid and a substantially insoluble component, which may be either a liquid or a finely divided solid.

A hydromechanical water treatment system based on hydrodynamic cavitation can be used to inhibit or kill macroorganisms and microorganisms in an aqueous system as a result of high shear, hydrodynamic cavitation forces, and/or other hydrodynamic changes in the aqueous system as it passes through the treatment system. Relative to microorganisms, e.g., bacteria and fungi, the shear and hydrodynamic forces can cause lysis of the cells. Most methods used to lyse bacterial and fungal cells are based on cavitation and shear effects. For example, ultrasound has been used to induce cavitation in liquids and, as a result, lysis of cells occurs. Other mechanical methods used in the past to disrupt cells have included ball mills, the application of high pressure followed by passage through a small diameter orifice, and violent vibration with inert particulates. These and other methods to physically disrupt microbial cells are described by Schnaitman, C. A., “Cell Fractionation,” Manual of Methods for General Bacteriology, Ch. 5, 52-61 (Gerhardt, P. et al., Eds. 1981), Coakley W. T. et al., “Disruption of Microorganisms,” Adv. Microbiol. Physiol. 16:279-341 (1977). Such methods to disrupt microbial cells have been designed and used to isolate specific cellular components such as protein, nucleic acids, and the like. However, such technologies are not practical for treating large volumes of water usually present in industrial settings.

There remains a need to improve efficiency of the hydrodynamic devices to control microorganisms in aqueous systems, particularily in industrial process waters.

There remains a need in the industry to reduce the amount of biocide used in industry.

### SUMMARY OF THE INVENTION

It has surprisingly been found that when biocides or combinations of biocides are used in conjunction with a hydrodynamic-based water treatment system an unexpectedly large increase in the effectiveness of the system is observed. The quantity of microbiological organism in the water being treated by the present invention is greatly decreased as compared to using the hydrodynamic-based water treatment system without the biocide or combinations of biocides.

The present invention provides a method for controlling microorganisms in industrial process water by treating the water with an effective amount of at least one or more biocides and a hydrodynamic-based water treatment device.

The amount of biocide used will be less that needed to inhibit microorganisms in the absence of the hydrodynamic treatment device.

### DETAILED DESCRIPTION OF THE INVENTION

The present invention is directed to using biocidal products, in combination with a hydrodynamic water treatment device to inhibit or control the growth of microorganisms in an aqueous system. Using a hydrodynamic water treatment device with a biocidal product allows for a lower amount of biocide to be used to inhibit or control growth of microorganisms. The present invention is suited for use in industrial water systems.

Using the present invention to control microorganisms provides an environmental benefit. Using the present invention results in acceptable control of microorganism while reducing the quantity of biocide added to the aqueous system. Aqueous streams treated by the present invention being returned to the ecosystem (lakes, stream etc . . . ) contain smaller quantities of biocides then if the present invention is not used

The hydrodynamic water treatment device is generally operated in the range of 50 to 200 psi, preferably in the range of 80 psi to 140 psi, more preferably in the range of 85 to 120 psi.

The flow rate will depend on the hydrodynamic water treatment device used. The flow rate can be as low as 50 gpm. The flow rate can be as high as 1500 gpm. The flow rate of the hydrodynamic water treatment device, in generally, is in the range of about 80 to 1000 gpm. The flow rate is based on the hydrodynamic water treatment device, its configuration, the pumps, the chamber of the device and the orifice setting of the device.

The water being treated is generally recycled through the hydrodynamic water treatment device. The water is recycled through the hydrodynamic water treatment device a number of times to achieve the desired microorganism inhibition. The number of passes through the hydrodynamic water treatment device depends on the level and kind of microorganisms in the aqueous system being treated and the desired percent of inhibition. Some systems have only a few passes through the system to achieve acceptable level while other aqueous systems require a higher number to passes through the hydrodynamic water treatment device. Generally it is desirable to have the number of passes less than 100, even more desirable is to have the number of passes less then 50, and most desirable is to have the number of passes less than 30.

The dosage amounts of a biocide or combinations of biocides, for use with a hydrodynamic water treatment device required for effectiveness in this invention generally depend on the nature of the aqueous system being treated, the level of organisms present in the aqueous system, and the level of inhibition desired. A person skilled in the art, using the information disclosed herein could determine the amount(s) necessary without undue experimentation.

In one embodiment of the present invention, the amount of biocide added to a water system is in the range of 0.01 to 100 mg per liter, preferably in the range of 0.1 to 50 mg per liter. The amount of biocide can be as high as 100 mg per liter, preferable up to 50 mg per liter or more preferably up to 10 mg per liter. The amount of biocide used can be less than 10 mg per liter, less than 8 mg per liter, less than 7 mg per less or less than 5 mg per liter. The amount of biocide is at least 0.01 mg per liter, preferably at least 0.1 mg per liter. The actual amount of biocide used will depend on the water system to be treated and which biocide(s) is used.

The use of the biocide in conjunction with the hydrodynamic water treatment device increases the effectiveness of the hydrodynamic water treatment device. Substantially lower dosages of biocide are added to the water system to control microorganism when the biocide is used in conjunction with a hydrodynamic water treatment device then when used alone.

It is believed that the hydrodynamic water treatment device produces the cavitation and/or increased shear in the water passing through the hydrodynamic water treatment device resulting in an inhibitory hydrodynamic effect wherein the microorganism are inhibited or killed.

As used herein, “inhibition” or “inhibit” refers to affecting microorganisms in a manner to render them unable to maintain viability, grow, reproduce, carryout normal metabolic activities, or adversely affect an industrial process water, the process for which the water is used, or the product produced.

For the purpose of the present invention, a hydrodynamic water treatment device is defined as a device designed to treat water by eliciting changes in one or more physico-chemical parameters of industrial process water by subjecting said water to high pressure and/or low pressure, and/or high flow rate, and/or high shear forces. The result of said treatment is changes in one or more parameters such as chemical composition, pH, temperature, concentration of dissolved gases, and number of viable microorganisms. The hydrodynamic water treatment device treats water by subjecting the water to hydrodynamic cavitation and/or high shear forces by pumping the water through components of the devise under conditions of high flow rate and pressure changes. It is understood that one or more of the conditions needed for hydrodynamic cavitation to occur also could be exploited as the basis for the invention described herein; such conditions include subjecting the liquid to regions of high pressure and low pressure while flowing at a high rate. It is also understood that high shear forces will be generated because of high flow rate and the nature of the device used.

As used herein, the term “microorganism” refers to any unicellular (including colonial) or filamentous organism. Microorganisms include all prokaryotes, fungi, protozoa, and some algae.

As used herein, “industrial process water” or “industrial water system” means water contained in recirculation and once through systems such as heat exchangers, heating and cooling systems, pulp and paper process systems, milk and dairy processing systems, food processing systems, and wastewater systems. It is obvious to one trained in the art that water contained in non-industrial systems could be also be treated according to the invention described herein. Such systems include, but are not limited to, aquatic systems such rivers, lakes, ponds, irrigation and retention ponds, fishponds, millponds, impoundments, lagoons, fountains, and reflecting and swimming pools. Pulp and paper process systems include, but are not limited to, whitewater, clarification units, wastewater treatment, intake water, either from a natural source(lake or stream) or public water source, and makedown water.

The present invention provides a method of treating water systems, particularly industrial water systems to inhibit or kill microbiological growth. The method comprises treating the industrial water with a hydrodynamic water treatment device and contacting the industrial water with a biocide. In one embodiment the biocide is added to the industrial water prior to treating the water with the hydrodynamic water treatment device.

The biocide can be added at intervals during the treatment of the water with the hydrodynamic water treatment device. In one embodiment the biocide are added to the water being treated with the hydrodynamic water treatment device at discrete intervals during the treatment.

In one embodiment of the invention the biocide is added to the water being treated both before the treatment with the hydrodynamic water treatment device and at discrete interval during the treatment of the water.

The biocide can be added continuously to the water being treated during the treatment of the water with the hydrodynamic water treatment device.

The biocide is present in the water being treated while the water is being treated by the hydrodynamic water treatment device.

The biocides that can be used with a hydrodynamic water treatment device to treat an industrial process water to inhibit or control microorganisms in the water include, but are not limited to, aldehydes, formaldehyde releasing compounds, halogenated hydrocarbons, phenolics, amides, halogenated amines and amides, carbamates, heterocyclic compounds containing nitrogen and sulfur atoms in the ring structure, electrophilic active substances having an halogen group in the a-position and/or in the vinyl position to an electronegative group, nucleophilic active substance having an alkyl group and at least one leaving group, and surface active agents. The halogenated amines are preferably chlorinated or brominated. An example of the preferred halogenated amine is monochloramine.

The aldehyde-containing compounds can be linear, branched, or aromatic. One example of an aldehyde useful in the invention is glutaraldehyde.

The formaldehyde-releasing compounds are preferably halogenated, methylated nitro-hydrocarbons, for example 2-bromo-2-nitro-propane-1,3-diol (Bronopol).

The amides are preferably halogenated, for example 2,2-dibromo-3-nitrilopropionamide (DBNPA).

The heterocyclic compounds useful in the invention include thiazole and isothiazolinone derivatives. Some examples of heterocyclic compounds include, but are not limited to, 5-chloro-2-methyl4-isothiazolin-3-one and 2-methyl4-isothiazolin-3-one.

Some electrophilic active substances include, but are not limited to, 1,2-dibromo-2,4-dicyanobutane, bis(trichloromethyl)sulfone, 4,5-dichloro-1,2-dithiol-3-one, and 2-bromo-2-nitrostyrene.

Additional examples of the non-oxidizing biocide useful in the invention include, but are not limited to, 2-n-octyl-4-isothiazolin-3-one; 4,5-dichloro-2-(n-octyl)4-isothiazolin-3-one; 1,2-benzisothiazolin-3-one; ortho-phthalaldehyde; 2-bromo4′-hydroxyacetophenone; methylene bisthiocyanate (MBTC); 2-(thiocyanomethylthio)benzothiazole; 3-iodopropynyl-N-butylcarbamate; n-alkyl dimethyl benzyl ammonium chloride; didecyl dimethyl ammonium chloride; alkenyl dimethylethyl ammonium chloride; 4,5-dichloro-1,2-dithiol-3-one; decylthioethylamine; n-dodecylguanidine hydrochloride; n-dodecylguanidine acetate; 1-(3-chloroallyl)-3,5,7-triaza-1-azoniaadamantane chloride; bis(1,4-bromoacetoxy)-2-butene; bis(1,2-bromoacetoxy)ethane; diiodomethyl-p-tolylsulfone; sodium ortho-phenylphenate; tetrahydro-3,5-dimethyl-2H-1,3,5-hydrazine-2-thione; cationic salts of dithiocarbamate derivatives; 4-chloro-3-methyl-phenol; 2,4,4′-trichloro-2′-hydroxy-diphenylether; poly(iminoimido-carbonyl-iminoimidocarbonyl-iminohexamethylene) hydrochloride and poly(oxyethylene(dimethyliminio)ethylene-(dimethyliminio)ethylene dichloride.

An additional biocide useful in the present invention is 4-chloro-2-(t-butylamino)-6-(ethylamino)-s-triazine.

### EXAMPLES

The “Experimental test system” used in the examples refers to a system comprised of a container or reservoir connected to a hydrodynamic water treatment device, “the VRTX system” via conduits for flow of a liquid from the reservoir to the hydrodynamic water treatment device and back into the reservoir.

The reservoir used in the studies reported herein was a polypropylene tank with a capacity of approximately 300 gallons. An opening near the bottom of the reservoir allowed it to be connected to the VRTX system via a 2-inch diameter pipe. Water exiting the VRTX system was returned to the reservoir via a 3-inch diameter pipe. To increase agitation of water in the reservoir, a submersible pump was placed in the middle of the reservoir. Water entered the submersible pump through the bottom and exited via a port on the top of the pump in an upward direction. The flow rate of the VRTX system was 80 gallons per minute (gpm). As described below, 80 gallons of water were used in each experiment. Therefore, for example, treating the water for 10 minutes allowed the total volume to pass through the hydrodynamic water treatment device 10 times.

As used herein, “VRTX system” refers to a non-chemical water treatment system available from VRTX Technologies, LLC (San Antonio, Tex.). The VRTX system is a hydrodynamic water treatment device and is based on a proprietary design whereby the intake stream of water is divided into two streams that enter a “reaction” chamber via nozzles that impart specific flow characteristics to the water streams. The chamber is designed to allow the water streams to enter from opposing points and collide in the center of the chamber. Because of the design of the nozzles and chamber, the water is subjected to hydrodynamic cavitation and high shear forces. The VRTX system used in the studies reported herein was one optimized for chemical treatment of industrial waters and, as such, the effect on microorganisms was less than if biological treatment of the water was an objective. It is obvious to one skilled in the art that there are other manners to induce hydrodynamic cavitation and high shear forces in order to treat water or other fluids.

As used herein, “basal salts solution” refers to solution prepared by first adding 15 ml of concentrated H₂SO₄ to 500 ml deionized water. The following chemicals were then dissolved in the dilute acid solution—KH₂PO₄ (6.0 g), MgSO₄ (1.2 g), AlKSO₄ (3.0 g), FeSO₄ (0.3 g), ZnSO₄ (0.3 g), and NaCl (1.5 g). Deionized water was added to increase the volume to 1.0 liter.

As used herein, “chemically defined water” means water used in the experimental test system prepared in the following steps: (1) filling the reservoir with 80 gallons of tap water; (2) neutralizing the residual chlorine by adding a minimal quantity of Na₂SO₃; chlorine was measured by the Hach DPD chlorine test kit (3) adding 1000 ml of basal salts solution; and (4) adjusting the pH of the water to 7.3 (+ or −0.2 pH unit) by adding 20% NaOH solution.

The Hach DPD chlorine test (Hach Company, Loveland, Colo.). Total available chlorine refers to the amount of chlorine in a sample that reacts with N,N-diethyl-p-phenylenediamine oxalate, the indicator used in the Hach assay. To determine the amount of chlorine in a sample, an aliquot of the sample is transferred to a clean container, diluted with deionized water, as appropriate, and assayed according to the Hach DPD chlorine test. The assay measures the total amount of chlorine that can react with the indicator reagent. The reaction is measured by determining the absorbance of light at 530 nm.

Following preparation of the chemically defined water, bacterial cells were added to an initial population density of approximately 1×10⁶ cells per milliliter. Unless otherwise noted, Escherichia coli was used as the test species. In some experiments, a papermill whitewater was used in lieu of the basal salts-tap water solution; when whitewater was used, the bacteria present in the water at the time of collection were used as the test species.

After the bacteria were added to the basal salts solution and allowed to circulate for 10-20 minutes to become evenly distributed in the water, a 1000 ml sample was aseptically collected and used as the control. This sample was maintained at room temperature on a magnetic stirrer and agitation was provided with a magnetic stir bar.

The efficacy of the treatment programs was determined based on changes in numbers of bacteria before and after the treatment program. Changes in numbers of bacteria were determined by employing the standard plate count technique. Samples of water were aseptically collected and serially diluted in 0.85% saline dilution blanks. One tenth milliliter samples of appropriate dilutions were aseptically transferred to tryptic soy agar plates and evenly distributed over the surface of the agar with a sterile bent glass rod. The agar plates were then incubated for 48 hours at 37° C. before the number of colonies were counted. The number of colonies is representative of the number of viable bacteria in the original water sample. The number of colonies is referred to as the “plate count” and is expressed as the number of colony-forming units (CFUs). In a typical experiment, the serial dilutions ranged from 10⁻² to 10⁻⁶. In all experiments, triplicate culture plates were prepared for each of three dilutions. Population sizes are reported as the average of the three plate counts.

The effect of the different treatment programs was determined based on percent difference in plate counts before and after treatment. Percent differences were calculated according to the equation:
% change=(Plate count before treatment−Plate count after treatment)/Plate count before treatment×100

As used herein, “initial population size” refers to the number of bacteria per milliliter as determined by the plate count technique in the chemically defined water immediately before testing commenced.

As used herein, “final population size” refers to the number of bacteria per milliliter as determined by the plate count technique in the chemically defined water at the end of testing.

Concentrations of two oxidizing biocides, Spectrum® XD3899 (Hercules Incorporated, Wilmington, Del.) and monochloramine, reported herein are in ppm as Cl₂. The units, milligrams per liter as Cl₂ (or mg/ml as Cl₂ or mg/ml), were determined based on the total available chlorine concentration in a sample as determined by the Hach DPD chlorine test (Hach Company, Loveland, Colo.). Total available chlorine refers to the amount of chlorine in a sample that reacts with N,N-diethyl-p-phenylenediamine oxalate, the indicator used in the Hach assay. To determine the amount of Cl₂ in a sample, an aliquot of the samples was transferred to a clean container, diluted with deionized water, as appropriate, and assayed according to the Hach DPD chlorine test. The assay measures the total amount of chlorine that can react with the indicator reagent. The reaction is measured by determining the absorbance of light at 530 nm. Therefore, for the purposes of this invention, a quantity of Spectrum® XD3899 or monochloramine presented in units of ppm signifies that amount of Spectrum® XD3899 or monochloramine added to the chemically defined water to result in the presence of the designated amount of ppm of reactive chlorine. Thus, for example, a sample treated with 1 mg per liter Spectrum®XD3899 will contain a total available chlorine concentration of 1 mg per liter.

The designated amount in ppm of products added to the chemically defined water or to papermill whitewater samples are based on the final concentration of active or product in the water. For example, the addition of 1 ppm of a commercially available biocide product indicates the presence of 1 mg per liter of the product in the total volume of water treated.

The designated amounts of actives added to the chemically defined water or to papermill whitewater samples are based on the final concentration of the specific compound in the water. For example, the addition of 1 ppm of a biocidal compound (also referred to as “active”) indicates the presence of 1 mg per liter of the specific compound in the total volume of water being treated.

In some examples wherein the product additions are referenced based on total actives. This refers to products that contain more than one compound with biocidal properties. For example, if a product contains two actives, the total amount of the actives (in ppm) is determined based on the concentration (in mg/l) of each active in the product. For example, if a product contains two actives in equal concentrations, the addition of 1 ppm of total actives indicates the presence of 0.5 mg per liter of the each specific compound in the total volume of water being treated.

The hydrodynamic water treatment device used in all the examples is the VRTX 80 (VRTX Technologies, San Antonio, Tex.) The VRTX 80 operates at about 80 gpm, the chamber pressure was about 100 psi. There is a vacuum of about −29 inches of Hg. The back pressure was set at about 2 to 4 psi.

The following examples are intended to be illustrative of the present invention. However, these examples are not intended to limit the scope of the invention or its protection in any way. The examples illustrate the synergistic relationship obtained in the present invention

### Example 1

This example demonstrates the effect of the hydrodynamic water treatment device, “the VRTX system”, on the size of the bacterial population in the experimental test system. As illustrated in Table 1, results from three experiments demonstrate the VRTX system has little measurable effect on the bacterial populations. The percent change in the population sizes for the three experiments are within the expected error for this type study.

TABLE 1
Effect of a hydrodynamic water treatment device
on the numbers of culturable Escherichia coli
in a chemically defined water system.

| | Concen- | Total | | | |
|---|---|---|---|---|---|
| | tration(s) | Treatment | Initial | Final | |
| | and Contact | Time | Population | Population | Percent |
| Experiment | Time(s) | (min.) | Size | Size | Change |
| 1 | NA | 50 | 8.97 × 10⁵ | 9.33 × 10⁵ | 4.09 |
| 2 | NA | 50 | 5.97 × 10⁶ | 5.60 × 10⁶ | −6.15 |
| 3 | NA | 60 | 3.83 × 10⁶ | 4.20 × 10⁶ | 9.57 |

Understanding that there was no significant effect of the VRTX system on numbers of E. coli in the chemically defined water, a series of studies was carried out to determine if the presence of chemical additives would affect performance of the VRTX system.

### Example 2

In this example, results demonstrated the effect of a biocidal product, Spectrum® RX4700 (Hercules, Incorporated, Wilmington, Del.) (Table 2). Spectrum® RX4700 contains 5% dodecylguanidine hydrochloride and 8% quaternary alkyldimethylbenzyl ammonium chloride as the active ingredients. The concentrations used in Example 2 are presented in units of ppm total actives. In this example, the treatment program consisted of the following steps: (1) water in the experimental test system was treated with the VRTX system for 20 minutes, (2) 1.1 ppm (total actives) of Spectrum® RX4700 was added, (3) 20-minute treatment with VRTX system, (4) another addition of 1.1 ppm (total actives) of Spectrum® RX4700, (5) 20-minute treatment with the VRTX system, (6) 4.4 ppm (total actives) of Spectrum® RX4700 added, and (7) 20-minute treatment. At the end of the 80-minute treatment during which a total of 6.6 ppm (total actives) of Spectrum® RX4700 was added to the water, samples were collected for counting the number of culturable bacteria. Spectrum® RX4700, in the absence of the VRTX system, caused a 42.3% reduction in the number of culturable bacteria, but a combination of Spectrum® RX4700 and the VRTX system caused a reduction of more than 99.99%.

TABLE 2
Changes in population sizes of Escherichia coli in chemically
defined water treated with Spectrum ® RX4700 with
and without a hydrodynamic water treatment device.

| | Concentration(s) | Total | Initial | Final | |
|---|---|---|---|---|---|
| | and Contact | Treatment | Population | Population | Percent |
| Treatment | Time(s) | Time (min.) | Size | Size | Change |
| Spectrum | 0 ppm for 20 min., | 80 | 3.90 × 10⁶ | 2.04 × 10⁶ | −42.30 |
| RX4700 | 1.1 ppm for 20 min., | | | | |
| | 2.2 ppm for 20 min., | | | | |
| | 6.6 ppm for 20 min. | | | | |
| Spectrum | 0 ppm for 20 min., | 80 | 3.90 × 10⁶ | <1 × 10² | >−99.99 |
| RX4700 + | 1.1 ppm for 20 min., | | | | |
| VRTX | 2.2 ppm for 20 min., | | | | |
| | 6.6 ppm for 20 min. | | | | |

### Example 3

Results of Example 3 are presented in Table 3. In this example, Spectrum® RX4700 was tested for efficacy against E. coli in the experimental test system with and without VRTX treatment. The treatment time was decreased to 40 minutes and the amount of biocide was decreased to a total of 6 ppm as product. For example, the total amount of Spectrum® RX4700 added was 6 ppm, but the total amount of actives was only 0.78 ppm. The results demonstrated that even with less treatment time and biocide than in Table 2, the combination of biocide+VRTX results in a 31.15% reduction in the number of culturable bacteria cells compared to a 5.53% increase with the biocide alone.

TABLE 3
Changes in population sizes of Escherichia coli in chemically
defined water treated with Spectrum ®RX4700 with
and without a hydrodynamic water treatment device.

| | Concentration(s) | Total | Initial | Final | |
|---|---|---|---|---|---|
| | and Contact | Treatment | Population | Population | Percent |
| Treatment | Time(s) | Time (min.) | Size | Size | Change |
| Spectrum | 5 ppm for 20 min., | 40 | 7.83 × 10⁵ | 1.30 × 10⁶ | 5.53 |
| RX4700 | 6 ppm for 20 min | | | | |
| Spectrum | 5 ppm for 20 min., | 40 | 7.83 × 10⁵ | 5.37 × 10⁵ | −31.15 |
| RX4700 + | 6 ppm for 20 min | | | | |
| VRTX | | | | | |

### Example 4

In table 4, whitewater collected from an alkaline fine papermachine was used in the experimental test system. The efficacy of Spectrum® RX4700 with and without the VRTX system was evaluated by incrementally adding the biocide in 1-ppm (total actives) increments. A five-minute treatment time was allowed between additions of the biocide. As illustrated in Table 4, the incremental additions of Spectrum® RX4700 to the whitewater resulted in a 46.69% reduction in plate counts in the absence of the VRTX system, but when the VRTX system was used, there was a 98.56% reduction in the number of culturable bacteria.

TABLE 4
Changes in population sizes of bacteria in whitewater treated with Spectrum ®RX4700
with and without a hydrodynamic water treatment device.

| | Concentration(s) | Total | Initial | Final | |
|---|---|---|---|---|---|
| | and Contact | Treatment | Population | Population | Percent |
| Treatment | Time(s) | Time (min.) | Size | Size | Change |
| Spectrum | 1 ppm for 5 min., | 30 | 2.01 × 10⁷ | 1.07 × 10⁷ | −46.69 |
| RX4700 | 2 ppm for 5 min., | | | | |
| | 3 ppm for 5 min., | | | | |
| | 4 ppm for 5 min., | | | | |
| | 5 ppm for 5 min., | | | | |
| | 6 ppm for 5 min. | | | | |
| Spectrum | 1 ppm for 5 min., | 30 | 2.01 × 10⁷ | 2.91 × 10⁵ | −98.56 |
| RX4700 + | 2 ppm for 5 min., | | | | |
| VRTX | 3 ppm for 5 min., | | | | |
| | 4 ppm for 5 min., | | | | |
| | 5 ppm for 5 min., | | | | |
| | 6 ppm for 5 min. | | | | |

### Example 5

Example 5, the effect of Spectrum® 3602 (Hercules Incorporated, Wilmington, Del.) was evaluated. Spectrum® RX3602 contains bis-trichloromethyl sulfone and quaternary alkyldimethylbenzyl ammonium chloride as the active ingredients. Incremental additions of 1 ppm (as product) of Spectrum® RX3602 were made at 10-minute intervals to the experimental test system. As illustrated in Table 5, adding 3 ppm Spectrum® RX3602 resulted in a 26% decrease in the population size of E. coli in the chemically defined water. A combination of Spectrum® RX3602 and the VRTX system caused the population size to decrease by 84.35%.

TABLE 5
Changes in population sizes of Escherichia coli in chemically
defined water treated with Spectrum ® RX3602 with
and without a hydrodynamic water treatment device.

| | Concentration(s) | Total | Initial | Final | |
|---|---|---|---|---|---|
| | and Contact | Treatment | Population | Population | Percent |
| Treatment | Time(s) | Time (min.) | Size | Size | Change |
| Spectrum | 1 ppm** for 10 min., | 50 | 3.83 × 10⁶ | 2.84 × 10⁶ | −26.00 |
| RX3602 | 2 ppm for 20 min., | | | | |
| | 3 ppm for 20 min. | | | | |
| Spectrum | 1 ppm** for 10 min., | 50 | 3.83 × 10⁶ | 6.00 × 10⁵ | −84.35 |
| RX3602 + | 2 ppm for 20 min., | | | | |
| VRTX | 3 ppm for 20 min. | | | | |

**measures as Product

### Example 6

Spectrum® RX1000 (Hercules Incorporated, Wilmington, Del.), contains bis-trichloromethyl sulfone and quaternary alkyldimethylbenzyl ammonium chloride in a formulation different from Spectrum® RX3602, was also tested in the experimental test system. The results demonstrated that incremental additions of 1 ppm of the product did not have an appreciable effect on the population size E. coli in the chemically defined water with or without the VRTX system (Table 6). The product was added in 1-ppm doses at 5-minute intervals during a 30-minutes treatment. The number of culturable bacteria decreased by 11.88% in the control (Spectrum® RX1000 only) system and only 2.93% in water treated with Spectrum® RX1000 and the VRTX system.

TABLE 6
Changes in population sizes of Escherichia coli in chemically
defined water treated with Spectrum ® RX1000 with
and without a hydrodynamic water treatment device.

| | Concentration(s) | Total | Initial | Final | |
|---|---|---|---|---|---|
| | and Contact | Treatment | Population | Population | Percent |
| Treatment | Time(s) | Time (min.) | Size | Size | Change |
| Spectrum | 1 ppm for 5 min., | 30 | 1.82 × 10⁶ | 1.61 × 10⁶ | −11.88 |
| RX1000 | 2 ppm for 5 min., | | | | |
| | 3 ppm for 5 min., | | | | |
| | 4 ppm for 5 min., | | | | |
| | 5 ppm for 5 min. | | | | |
| Spectrum | 1 ppm for 5 min., | 30 | 1.82 × 10⁶ | 1.77 × 10⁶ | −2.93 |
| RX1000 + | 2 ppm for 5 min., | | | | |
| VRTX | 3 ppm for 5 min., | | | | |
| | 4 ppm for 5 min., | | | | |
| | 5 ppm for 5 min. | | | | |

### Example 7

In this example, the effect of 1 ppm Spectrum® XD3899, an ammonium bromide-based biocide sold by Hercules, Inc. Spectrum® XD3899 is a biocide produced when ammonium bromide reacts with sodium hypochlorite producing an effective biocide for industrial applications (U.S. Pat. No. 5,976,386, the content of which is herein incorporated by reference). In this example, the first experiment included a single challenge of 1 ppm (as Cl—) and a 25-minute treatment time. The difference in the system receiving Spectrum® XD3899 and VRTX treatment was significant as the population declined by 36.26% with Spectrum® XD3899 but by 93.6% when the VRTX system was used with Spectrum® XD3899 (Table 7). The second experiment used only 0.25-ppm Spectrum® XD3899 (as measured by Cl— concentration) and no difference was detected between the two treatments after a 50-minute treatment period.

TABLE 7
Changes in population sizes of Escherichia coli in chemically
defined water treated with Spectrum ® XD3899 with
and without a hydrodynamic water treatment device.

| | Concentration(s) | Total | Initial | Final | |
|---|---|---|---|---|---|
| | and Contact | Treatment | Population | Population | Percent |
| Treatment | Time(s) | Time (min.) | Size | Size | Change |
| Spectrum | 1 ppm for 25 min. | 25 | 1.44 × 10⁶ | 9.20 × 10⁵ | −36.26 |
| XD3899 | | | | | |
| Spectrum | 1 ppm for 25 min. | 25 | 1.44 × 10⁶ | 9.24 × 10⁴ | −93.60 |
| XD3899 + | | | | | |
| VRTX | | | | | |
| Spectrum | 0.25 ppm for 25 min. | 50 | 6.60 × 10⁶ | 5.70 × 10⁶ | −13.63 |
| XD3899 | | | | | |
| Spectrum | 0.25 ppm for 25 min. | 50 | 6.60 × 10⁶ | 5.40 × 10⁶ | −18.18 |
| XD3899 + | | | | | |
| VRTX | | | | | |

### Example 8

In this example, the efficacy of monochloramine was evaluated in the presence and absence of the VRTX system. The results demonstrated a slight reduction (18.88%) in the E. coli population when 0.5 ppm (measured as total chlorine) monochloramine was added to the chemically-define water. However, 0.5-ppm monochloramine and the VRTX system caused a 59.14% reduction in the population size.

TABLE 8
Changes in population sizes of Escherichia coli in chemically
defined water treated with Monochloramine with and without
a hydrodynamic water treatment device.

| | Concentration(s) | Total | Initial | Final | |
|---|---|---|---|---|---|
| | and Contact | Treatment | Population | Population | Percent |
| Treatment | Time(s) | Time (min.) | Size | Size | Change |
| Monochloramine | 0.5 ppm (as Cl⁻) | 50 | 2.26 × 10⁶ | 1.83 × 10⁶ | −18.88 |
| | for 50 min. | | | | |
| Monochloramine + | 0.5 ppm (as Cl⁻) | 50 | 2.26 × 10⁶ | 9.23 × 10⁵ | −59.14 |
| Vortex | for 50 min. | | | | |

### Example 9

Hydrogen peroxide was also tested for biocidal properties in the experimental test system. In this example, 10-ppm additions of H₂O₂ were made after the indicated treatment times. During a 50-minutes treatment period, the total amount of H₂O₂ added was 40 ppm. The H₂O₂ alone caused a 20.88% reduction in the population size of E. coli (Table 9). However, there was a 62.94% reduction when 40 ppm H₂O₂ was added to the water being treated with the VRTX system.

TABLE 9
Changes in population sizes of Escherichia coli in chemically
defined water treated with hydrogen peroxide (H₂O₂) with
and without a hydrodynamic water treatment device.

| | Concentration(s) | Total | Initial | Final | |
|---|---|---|---|---|---|
| | and Contact | Treatment | Population | Population | Percent |
| Treatment | Time(s) | Time (min.) | Size | Size | Change |
| H₂O₂ | 10 ppm for 30 min., | 50 | 2.27 × 10⁶ | 1.79 × 10⁶ | −20.88 |
| | 20 ppm for 5 min., | | | | |
| | 40 ppm for 15 min. | | | | |
| H₂O₂ + | 11 ppm for 30 min., | 50 | 2.27 × 10⁶ | 8.40 × 10⁵ | −62.94 |
| VRTX | 20 ppm for 5 min., | | | | |
| | 40 ppm for 15 min. | | | | |

### Example 10

In this example, the effects of Spectrum® RX9800, a glutaraldehyde-based product, were evaluated in the experimental test system. A 5-minute treatment period was allowed before a series of incremental additions of glutaraldehyde. The results demonstrate that 46.92% of the E. coli cells were inhibited by 5 ppm glutaraldehyde, but the percent inhibited was 99.88% when the VRTX system was used to treat water amended with 5 ppm glutaraldehyde.

TABLE 10
Changes in population sizes of Escherichia coli in chemically
defined water treated with glutaraldehyde with and without
a hydrodynamic water treatment device.

| | Concentration(s) | Total | Initial | Final | |
|---|---|---|---|---|---|
| | and Contact | Treatment | Population | Population | Percent |
| Treatment | Time(s) | Time (min.) | Size | Size | Change |
| Glutaraldehyde | 0 ppm for 5 min., | 55 | 2.92 × 10⁶ | 1.55 × 10⁶ | −46.92 |
| | 1 ppm for 10 min., | | | | |
| | 2 ppm for 10 min., | | | | |
| | 3 ppm for 10 min., | | | | |
| | 4 ppm for 10 min., | | | | |
| | 5 ppm for 10 min. | | | | |
| Glutaraldehyde + | 0 ppm for 5 min., | 55 | 2.92 × 10⁶ | 3.50 × 10³ | −99.88 |
| VRTX | 1 ppm for 10 min., | | | | |
| | 2 ppm for 10 min., | | | | |
| | 3 ppm for 10 min., | | | | |
| | 4 ppm for 10 min., | | | | |
| | 5 ppm for 10 min. | | | | |

### Example 11

In this example, studies were carried out to determine if the combined effect of the VRTX system and dodecylguanidine hydrochloride or quaternary alkyldimethylbenzyl ammonium chloride would be similar to the effect detected for Spectrum®RX470.0. Dodecylguanidine hydrochloride and quaternary alkyldimethylbenzyl ammonium chloride are compounds known to affect the membranes of cells. As illustrated in Table 11, incremental additions of 0.1 ppm of dodecylguanidine hydrochloride at 10-minute intervals during a 40-minute treatment period resulted in a 15.35% decrease in the population size of E. coli in the absence of the VRTX system. When dodecylguanidine hydrochloride (“DGH”) was tested with the VRTX system, there was a 55.71% decrease in the population size.

TABLE 11
Changes in population sizes of Escherichia coli in chemically
defined water treated with dodecylguanidine hydrochloride (DGH)
with and without a hydrodynamic water treatment device.

| | Concentration(s) | Total | Initial | Final | |
|---|---|---|---|---|---|
| | and Contact | Treatment | Population | Population | Percent |
| Treatment | Time(s) | Time (min.) | Size | Size | Change |
| DGH | 0.1 ppm for 10 min., | 40 | 2.08 × 10⁶ | 1.46 × 10⁶ | −15.35 |
| | 0.2 ppm for 10 min., | | | | |
| | 0.3 ppm for 10 min., | | | | |
| | 0.4 ppm for 10 min | | | | |
| DGH + | 0.1 ppm for 10 min., | 40 | 2.08 × 10⁶ | 8.40 × 10⁵ | −55.71 |
| VRTX | 0.2 ppm for 10 min., | | | | |
| | 0.3 ppm for 10 min., | | | | |
| | 0.4 ppm for 10 min | | | | |

### Example 12

In this example, 0.1-ppm additions of quaternary alkyldimethylbenzyl ammonium chloride were made to the experimental test system at 10-minute intervals during a 40-minute treatment period.

TABLE 12
Changes in population sizes of Escherichia coli in chemically defined
water treated with quaternary alkyldimethylbenzyl ammonium chloride
(Quat) with and without a hydrodynamic water treatment device.

| | Concentration(s) | Total | Initial | Final | |
|---|---|---|---|---|---|
| | and Contact | Treatment | Population | Population | Percent |
| Treatment | Time(s) | Time (min.) | Size | Size | Change |
| Quat | 0.1 ppm for 10 min., | 40 | 1.35 × 10⁶ | 1.12 × 10⁶ | −17.04 |
| | 0.2 ppm for 10 min., | | | | |
| | 0.3 ppm for 10 min., | | | | |
| | 0.4 ppm for 10 min. | | | | |
| Quat + | 0.1 ppm for 10 min., | 40 | 1.35 × 10⁶ | 1.10 × 10⁶ | −18.27 |
| VRTX | 0.2 ppm for 10 min., | | | | |
| | 0.3 ppm for 10 min., | | | | |
| | 0.4 ppm for 10 min. | | | | |

### Example 13

As illustrated in Examples 11 and 12, there was a difference in the efficacies of equal amounts of dodecylguanidine hydrochloride and quaternary alkyldimethylbenzyl ammonium chloride with or without the VRTX system. Studies were carried out on structurally similar compounds to dodecylguanidine hydrochloride. As illustrated in Table 13, there was a difference in efficacies of the compounds tested.

TABLE 13
Changes in population sizes of Escherichia coli in chemically defined water treated with
octylguanidine hydrochloride with and without a hydrodynamic water treatment device

| | Concentration(s) | Total | Initial | Final | |
|---|---|---|---|---|---|
| | and Contact | Treatment | Population | Population | Percent |
| Treatment | Time(s) | Time (min.) | Size | Size | Change |
| Octylguanidine | 0.5 ppm for 10 min., | 30 | 1.86 × 10⁶ | 2.04 × 10⁶ | 9.9 |
| hydrochloride | 1.0 ppm for 10 min., | | | | |
| | 1.5 ppm for 10 min | | | | |
| Octylguanidine | 0.5 ppm for 10 min., | 30 | 1.86 × 10⁶ | 1.67 × 10⁶ | −9.9 |
| hydrochloride + | 1.0 ppm for 10 min., | | | | |
| VRTX | 1.5 ppm for 10 min | | | | |
| Tetradecyl guanidine | 0.5 ppm for 10 min., | 30 | 1.76 × 10⁶ | 1.77 × 10⁶ | 0.8 |
| hydrochloride | 1.0 ppm for 10 min., | | | | |
| | 1.5 ppm for 10 min | | | | |
| Tetradecyl guanidine | 0.5 ppm for 10 min., | 30 | 1.76 × 10⁶ | 8.50 × 10⁵ | −51.6 |
| hydrochloride + | 1.0 ppm for 10 min., | | | | |
| VRTX | 1.5 ppm for 10 min | | | | |

### Example 14

Bellacide® 350, a tributyl tetradecyl phosphonium chloride, was evaluated for activity with and without the VRTX system. As illustrated in Table 14, incremental additions of 0.5-ppm active ingredient at 10-minute intervals resulted in a decrease of 13.51% in culturable counts. However, when added to water being treated with the VRTX system, there was a 63.13% reduction in culturable counts.

TABLE 14
Changes in population sizes of Escherichia coli in chemically
defined water treated with tributyl tetradecyl phosphonium chloride
with and without a hydrodynamic water treatment device.

| | Concentration(s) | Total | Initial | Final | |
|---|---|---|---|---|---|
| | and Contact | Treatment | Population | Population | Percent |
| Treatment | Time(s) | Time (min.) | Size | Size | Change |
| Bellacide | 0.5 ppm for 10 min., | 40 | 1.73 × 10⁶ | 1.70 × 10⁶ | −13.51 |
| 350 | 1.0 ppm for 10 min., | | | | |
| | 1.5 ppm for 10 min., | | | | |
| | 2.0 ppm for 10 min. | | | | |
| Bellacide | 0.5 ppm for 10 min., | 40 | 1.73 × 10⁶ | 6.37 × 10⁵ | −63.13 |
| 350 + VRTX | 1.0 ppm for 10 min., | | | | |
| | 1.5 ppm for 10 min., | | | | |
| | 2.0 ppm for 10 min. | | | | |

### Example 15

In this example, 2-(Decylthio)ethylamine was tested for efficacy in the experimental test system. In Table 15, 3 ppm of 2-(Decylthio)ethylamine resulted in a 6.77% decrease in the E. coli population. There was a 98.62% decrease in the E. coli population when 3 ppm of 2-(Decylthio)ethylamine was added to the chemically defined water that was treated with the VRTX system.

TABLE 15
Changes in population sizes of Escherichia coli in chemically
defined water treated with 2-(Decylthio)ethylamine (“DTEA”)
with and without a hydrodynamic water treatment device.

| | Concentration(s) | Total | Initial | Final | |
|---|---|---|---|---|---|
| | and Contact | Treatment | Population | Population | Percent |
| Treatment | Time(s) | Time (min.) | Size | Size | Change |
| DTEA | 1 ppm for 10 min., | 30 | 1.58 × 10⁶ | 1.68 × 10⁶ | 6.77 |
| | 2 ppm for 10 min., | | | | |
| | 3 ppm for 10 min. | | | | |
| DTEA + | 1 ppm for 10 min., | 30 | 1.58 × 10⁶ | 2.17 × 10⁴ | −98.62 |
| VRTX | 2 ppm for 10 min., | | | | |
| | 3 ppm for 10 min. | | | | |

### Example 16

In this example, poly(iminoimidocarbonyl-iminoimidocarbonyl-iminohexamethylene)hydrochloride (Vantocil® 1B) (Arch Chemicals, Inc., West Yorkshire, United Kingdom) was evaluated for activity in the experimental test system. As illustrated in Table 16, 0.2 ppm of Vantocil 1B resulted in a 66.28% decrease in the E. coli population, compared with a 97.57% reduction when the VRTX system was used in the presence of 0.2 ppm Vantocil 1B.

TABLE 16
Changes in population sizes of Escherichia coli
in chemically defined water treated with
poly(iminoimidocarbonyl-iminoimidocarbonyliminohexamethylene)
hydrochloride (Vantocil ® 1B) with and
without a hydrodynamic water treatment device.

| | Concentration(s) | Total | Initial | Final | |
|---|---|---|---|---|---|
| | and Contact | Treatment | Population | Population | Percent |
| Treatment | Time(s) | Time (min.) | Size | Size | Change |
| Vantocil 1B | 0.1 ppm for 10 min., | 20 | 1.42 × 10⁶ | 4.80 × 10⁵ | −66.28 |
| | 0.2 ppm for 10 min. | | | | |
| Vantocil 1B + | 0.1 ppm for 10 min., | 20 | 1.42 × 10⁶ | 3.45 × 10⁴ | −97.57 |
| Vortex | 0.2 ppm for 10 min. | | | | |

While this invention has been described with respect to particular embodiments thereof, it is apparent that numerous other forms and modifications of the invention will be obvious to those skilled in the art. The appended claims and this invention generally should be construed to cover all such obvious forms and modifications which are within the true spirit and scope of the present invention.

What is claimed is:

1. A method for controlling the growth of microorganisms in water systems comprising the steps of:
a) treating the water system with a hydrodynamic-based water treatment device; and
b) adding at least one biocide to the water system being treated, to inhibit the growth of the microorganisms

2. The method of claim 1, wherein the hydrodynamic-based water treatment device creates hydrodynamic cavitation in the water passing through the hydrodynamic water treatment device.

3. The method of claim 1, wherein the wherein the hydrodynamic-based water treatment device creates shear in the water passing through the hydrodynamic water treatment device.

4. The method of claim 1, wherein the hydrodynamic-based water treatment device creates hydrodynamic cavitation and shear in the water passing through the hydrodynamic water treatment device.

5. The method of claim 1, wherein the water system is industrial process water.

6. The method of claim 5, wherein the industrial process water is a paper process system.

7. The method of claim 1 wherein the water system is in a natural or man-made surface or sub-surface aquatic system.

8. The method of claim 1, wherein the biocide is selected from the group consisting of 1,2-dibromo- 2,4-dicyanobutane, 2,2-dibromo-3-nitrilopropionamide (DBNPA), bis(trichloromethyl)sulfone, 4,5-dichloro-1,2-dithiol-3-one, 2-bromo-2-nitrostyrene, 5-chloro-2-methyl4-isothiazolin-3-one (CMIT), 2-methyl4-isothiazolin-3-one (MIT), 2-n-octyl-4-isothiazolin-3-one; 4,5-dichloro-2-(n-octyl)4-isothiazolin-3-one; 1,2-benzisothiazolin-3-one; glutaraldehyde; ortho-phthalaldehyde; 2,2-dibromo-3-nitrilopropionamide (DBNPA) ; 2-bromo-2-nitrostyrene, 2-nitrostyrene; 2-bromo4′-hydroxyacetophenone; methylene bisthiocyanate (MBTC); 2-(thiocyanomethylthio)benzothiazole; 3-iodopropynyl-N-butylcarbamate; n-alkyl dimethyl benzyl ammonium chloride; didecyl dimethyl ammonium chloride; alkenyl dimethylethyl ammonium chloride; 4,5-dichloro-1,2-dithiol-3-one; decylthioethylamine; 2-bromo-2-nitropropane-1, 3-diol; n-dodecylguanidine hydrochloride; n-dodecylguanidine acetate; 1-(3-chloroallyl)-3,5,7-triaza-1-azoniaadamantane chloride; 1,2-dibromo-2,4-dicyanobutane; bis(1,4-bromoacetoxy)-2-butene; bis(1,2-bromoacetoxy)ethane; bis(trichloromethyl)sulfone; diiodomethyl-p-tolylsulfone; sodium ortho-phenylphenate; tetrahydro-3,5-dimethyl-2H-1,3,5-hydrazine-2-thione; cationic salts of dithiocarbamate derivatives; 4-chloro-3-methyl-phenol; 2,4,4′-trichloro-2′-hydroxy-diphenylether; poly(oxyethylene(dimethyliminio) ethylene-(dimethyliminio)ethylene dichloride.

9. The method of claim 1 wherein the biocide comprises an quaternary alkyldimethylbenzyl ammonium chloride amine.

10. The method of claim 1 wherein the biocide comprises halogenated amine.

11. The method of claim 1 wherein the biocide comprises glutaraldehyde.

12. The method in claim 1, wherein two or more biocides are used in combination with a hydrodynamic water treatment device.

13. The method of claim 1 wherein the amount of biocide used is less than about 7 mg per liter.

14. A method for controlling the growth of microorganisms in water comprising the steps of adding an amount of biocide to the water that is less than the amount needed to inhibit microorganisms present in said water and treating the water with a hydrodynamic-based water treatment device that imparts sufficient hydrodynamic forces on the water and microorganisms therein to inhibit said microorganisms at an extent or at a rate greater than in the absence of the biocide
